(19) United States
(12) Patent Application Publication
(10) Pub. No.: US 2011/0236266 A1
(43) Pub. Date: Sep. 29, 2011

(54) OPTICAL SENSOR

(76) Inventors: Ikuo Uematsu, Yokohama-shi (JP); Shingo Kasai, Yokohama-shi (JP); Ichiro Tohno, Yokohama-shi (JP); Isao Nawata, Yokohama-shi (JP)

(21) Appl. No.: 13/039,748

(22) Filed: Mar. 3, 2011

(30) Foreign Application Priority Data
Mar. 24, 2010 (JP) 2010-068426

(51) Int. Cl. G01N 21/00; G01N 1/10

(52) U.S. Cl. 422/82.11; 356/246

(57) ABSTRACT

According to one embodiment, an optical sensor includes an optical waveguide module and a specimen area. The specimen area is provided adjacent to the optical waveguide module, and is configured to hold a specimen. The specimen area includes a sensing area and a precipitation area. An optical change occurs in the sensing area. A precipitate of the specimen is precipitated in the precipitation area. The precipitation area is placed at a different position from a position of the sensing area which is attached to the optical waveguide module.

### CROSS-REFERENCE TO RELATED APPLICATIONS

This application is based upon and claims the benefit of priority from Japanese Patent Application No. 2010-068426, filed Mar. 24, 2010; the entire contents of which are incorporated herein by reference.

### FIELD

Embodiments described herein relate generally to an optical sensor.

### BACKGROUND

As methods for detecting a to-be-measured substance of a specimen such as blood, there are known electrical detection, optical detection and surface plasmon detection.

In an optical sensor having an optical waveguide structure, an optical change on an interface (sensing surface) between an optical waveguide layer and a specimen is detected, and thereby a to-be-measured substance, and a substance or a reaction product, which occurs due to the to-be-measured substance, are detected. In usual cases, in such an optical sensor, in order to hold a specimen, a specimen area is upwardly disposed, and an optical waveguide layer is disposed under the specimen area. The specimen is held in the specimen area, and a to-be-measured substance on a sensing surface that is the lower surface of the specimen area, and a substance or a reaction product, which occurs due to the to-be-measured substance, are detected in the form of optical changes.

However, in the case where there is a precipitate in the specimen, which precipitates by its own weight, the precipitate deposits on the sensing surface, which is the lower surface of the specimen area, in the above-described upwardly disposed specimen area. Consequently, in some cases, the detection of the to-be-measured substance, and the substance or reaction product, which occurs due to the to-be-measured substance, is physically or chemically hindered by the precipitate.

### BRIEF DESCRIPTION OF THE DRAWINGS

FIG. 1 is a cross-sectional view of an optical sensor according to a first embodiment of the invention;

FIG. 2 is a plan view of the optical sensor;

FIG. 3 is a bottom view of a sensor chip of the optical sensor;

FIG. 4 is an explanatory view showing a specimen area of the optical sensor;

FIG. 5 is a cross-sectional view of an optical sensor according to a second embodiment of the invention;

FIG. 6 is a cross-sectional view of an optical sensor according to a third embodiment of the invention;

FIG. 7 is a bottom view of a sensor chip of the optical sensor of the third embodiment;

FIG. 8 is an explanatory view of a specimen area of an optical sensor according to a fourth embodiment of the invention;

FIG. 9 is an explanatory view illustrating an antigen-antibody reaction in the fourth embodiment; and

FIG. 10 is an explanatory view illustrating an antigen-antibody reaction in the fourth embodiment.

### DETAILED DESCRIPTION

In general, according to one embodiment, an optical sensor includes an optical waveguide module and a specimen area. The specimen area is provided adjacent to the optical waveguide module, and is configured to hold a specimen. The specimen area includes a sensing area and a precipitation area. An optical change occurs in the sensing area. A precipitate of the specimen is precipitated in the precipitation area. The precipitation area is placed at a different position from a position of the sensing area which is attached to the optical waveguide module.

### First Embodiment

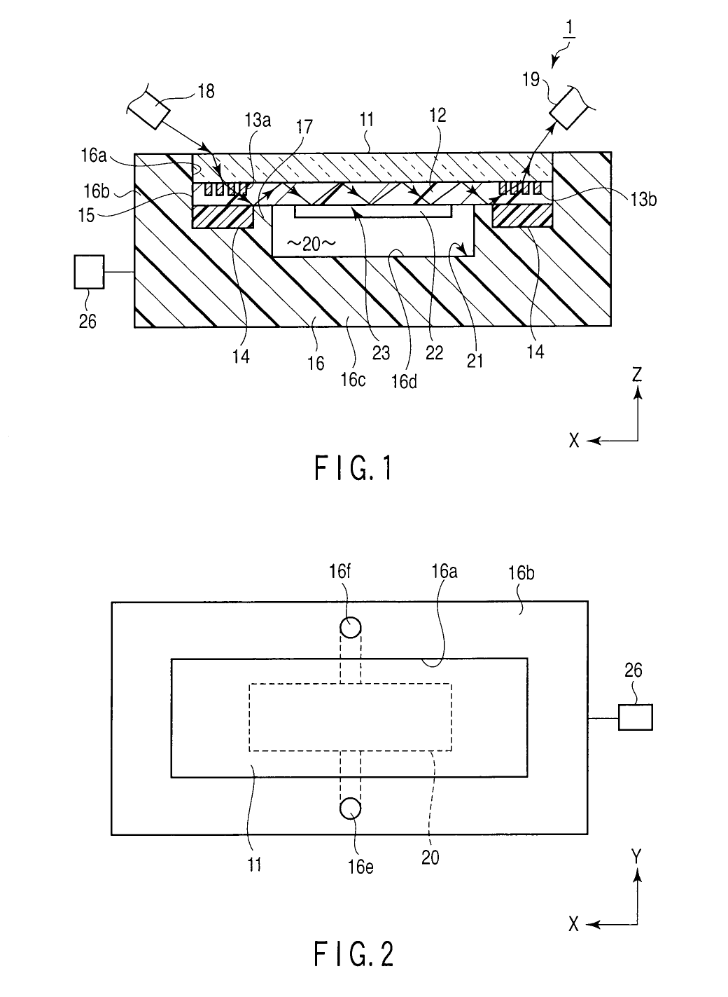

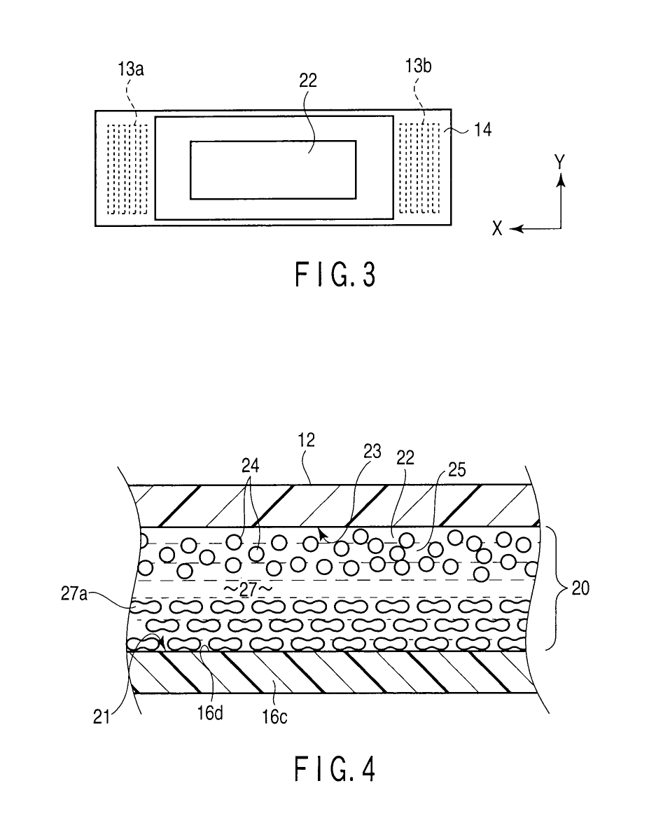

An optical sensor 1 according to a first embodiment of the invention will now be described with reference to FIG. 1 to FIG. 4. FIG. 1 is a cross-sectional view of the optical sensor 1 according to the first embodiment, and FIG. 2 is a plan view of the optical sensor 1. FIG. 3 is a bottom view of a sensor chip 15, and FIG. 4 is an explanatory view of a specimen area 20.

The optical sensor 1 is an optical waveguide-type biochemical sensor chip. The optical sensor 1 comprises a sensor chip 15 and a chamber 16 which is opposed to the sensor chip 15. The sensor chip 15 includes a substrate 11, an optical waveguide layer 12 (optical waveguide module), an incidence grating 13a, an emission grating 13b, and a protection film 14. A specimen area 20 is formed between the sensor chip 15 and the chamber 16.

The substrate 11 is formed of glass (e.g. no-alkali glass) or quartz in a plate shape with light transmissivity. The substrate 11 is disposed in a recess portion 16a of the chamber 16.

The paired gratings 13a and 13b, which make light incident on the substrate 11 and make light emit from the substrate 11, respectively, are formed on both end regions of a lower major surface of the substrate 11. The incidence grating 13a and emission grating 13b are provided in contact with the optical waveguide layer 12 and are spaced apart from each other. The gratings 13a and 13b are formed of a material (e.g. titanium oxide) having a higher refractive index than a material of which the substrate 11 is formed.

The optical waveguide layer 12 is a film body with a uniform thickness in a range of, e.g. 3 to 300 μm. The optical waveguide layer 12 is formed such that the optical waveguide layer 12 neighbors, and is in close contact with, the lower surface of the substrate 11, on which the gratings 13a and 13b are formed. The optical waveguide layer 12 is formed of a material having a higher refractive index than the substrate 11, and is composed of, for instance, high-molecular-weight resin, silicon oxide, glass, titanium oxide, or an organic material.

The protection film 14 is formed of a material (e.g. fluororesin) which has a lower refractive index than the material of the optical waveguide layer 12 and reacts with none of reagents which are put in the sensor chip 15. The protection film 14 is formed in a manner to neighbor the lower surface of the optical waveguide layer 12 such that the protection film 14 covers both end portions of the optical waveguide layer 12, which correspond to the regions where the gratings 13a and 13b are formed, or in other words, that the protection film 14 covers regions corresponding to the gratings 13a and 13b.

The substrate 11, optical waveguide layer 12, gratings 13a and 13b and protection film 14 are stacked, thereby forming the sensor chip 15. The sensor chip 15 is provided in the recess portion 16a of the chamber 16. The specimen area 20 is formed between the optical waveguide layer 12 of the sensor chip 15 and the bottom surface of the chamber 16.

A light source 18 (e.g. laser diode) and a light reception element 19 (e.g. photodiode) are disposed, respectively, on one end side and the other end side of the back surface (the upper surface in FIG. 1) of the substrate 11.

The chamber 16 is formed of, e.g. an acrylic material, has a rectangular plate-like outer shape, and constitutes an outer shell of the optical sensor 1. The chamber 16 is configured to integrally comprise a side wall portion 16b surrounding the outer periphery of the sensor chip 15, a bottom wall portion 16c disposed under the sensor chip 15 and opposed to the sensor chip 15 via the specimen area 20, and a peripheral wall portion 17 surrounding the specimen area 20 on the inside of the side wall portion 16b. The recess portion 16a, which accommodates the sensor chip 15, is formed in a central part of the upper surface of the chamber 16. Specifically, the specimen area 20, which is a hollow part, is formed under the recess portion 16a between the chamber 16 and the optical waveguide layer 12. The sensor chip 15 is set in an upper part of the inside of the recess portion 16a, with the specimen area 20 being interposed between the chamber 16 and the sensor chip 15. The chamber 16 is formed of, e.g. a black material as a whole, and is configured to have light-blocking properties. The upper surface of the bottom wall portion 16c is an opposite surface 16d which is opposed to the light waveguide layer 12 via the specimen area 20. The chamber 16 and the sensor chip 15 are fixed to each other by means of, for example, a light-blocking double-coated adhesive tape (not shown).

A liquid feed path 16e for communication between the outside and the specimen area 20 is formed in the side wall portion 16b or bottom wall portion 16c of the chamber 16. A specimen 27 is introduced into the specimen area 20 via the liquid feed path 16e. In addition, the chamber 16 is provided with an escape portion 16f for letting a fluid escape when the specimen 27 is introduced. The escape portion 16f is formed, for example, as a conduit, a hole or a space, which communicates with the outside of the chamber 16.

The specimen area 20 is a hollow space which is provided adjacent to the optical waveguide layer 12. The dimension in a Z direction of the specimen area 20 is set at about 1 mm to 10 mm. The specimen 27 is filled and held in the specimen area 20. The specimen 27 is a specimen liquid including a to-be-measured substance, a precipitate 27a, a solvent, etc.

As shown in FIG. 4, the lower surface of the specimen area 20, that is, the opposite surface 16d, serves as a precipitation surface 21 (precipitation area) on which the precipitate 27a, such as blood cells, in the specimen 27 precipitates by its own weight.

The specimen area 20 is provided with a sensing film 22 (reaction layer). The upper surface of the sensing film 22, which is the interface with optical waveguide layer 12, serves as a sensing surface 23 (sensing area) on which an optical change occurs.

In this embodiment, the specimen area 20 is downwardly disposed, the precipitation surface 21 is the opposite surface 16d of the chamber 16, which is the lower surface of the specimen area 20, and the sensing surface 23 is the interface with the optical waveguide layer 12, which is the upper surface of the specimen area 20. Specifically, the precipitation surface 21 and sensing surface 23 of the specimen area 20 are disposed at mutually different positions, and are spaced apart in the up-and-down direction. By this disposition, the precipitate 27a, such as blood cells, does not come in contact with the sensing surface 23.

The sensing film 22 is provided with reaction reagents 25 which react with the specimen 27. As the reaction reagents 25, for example, labeled antibodies which are coupled to the specimen 27 by antigen-antibody reactions, reagents which produce reaction products by reacting with labels, and catalysts which accelerate reactions between labels and reagents, are properly combined according to the kinds of chemicals and are stored. The sensing film 22 may be formed on the upper side of the specimen area 20, that is, in a part on the optical waveguide layer 12 side, or may be formed in the entirety of the specimen area 20.

The reactions of the specimen 27 in the sensing film 22 are, for instance, biomolecule recognition reactions including an antigen-antibody reaction and an enzyme reaction, or coloring or fluorescence reactions utilizing reaction products occurring from biomolecule recognition reactions.

The sensing film 22 includes holding structures 24 which hold to-be-measured objects on the sensing surface 23. Examples of the holding structures 24 are beads, a water-absorbing sheet which is a hydrophilic absorption film, gold colloid, a meshed holding member, and a porous holding member.

For example, in the case where the sensing film 22 is a glucose sensing film, the sensing film 22 includes, as the reaction reagents 25, a glucose oxidizing enzyme or reducing enzyme, a reagent which generates a substance that causes a color producing reagent to produce a color by reacting with a product by the enzyme, a color producing reagent, and a film-forming high-molecular-weight resin, and further includes, where necessary, a water-permeability accelerator, such as polyethylene glycol, as the holding structures 24.

The sensing surface 23, which is the upper surface of the specimen area 20 and sensing film 22, is a surface which is positioned in a region interposed between the protection films 14 located on a line segment connecting the gratings 13a and 13b, and neighbors, in close contact with, the surface of the optical waveguide layer 12. The sensing surface 23 causes an optical change, such as varying the intensity of light propagating through the optical waveguide layer 12 in accordance with the quantity or concentration of the to-be-measured object in the introduced specimen 27.

The optical change occurring at the sensing surface 23 is, for example, color production (reaction), fluorescence (reaction), light emission, absorption, scattering, or a variation in refractive index.

Besides, the optical sensor 1 includes a stirring mechanism 26 for stirring the specimen 27 and reaction reagents 25 in the specimen area 20. The stirring mechanism 26 is configured to include, for example, a pump which is disposed outside the chamber 16 and communicates with the specimen area 20. The stirring mechanism 26 stirs the specimen 27 and reagents which are introduced in the specimen area 20, thereby setting them in an easily separable state.

Next, a measuring method by the optical sensor 1 with the above-described structure is described. In the case where the precipitate 27 is present, the specimen is introduced and stirred, and a light amount variation measurement is performed while the precipitate 27a is being precipitated.

If a laser beam is made incident on the upper surface of the substrate 11 from the laser diode serving as the light source 18, the laser beam travels through the substrate 11, and is refracted at the interface between the incidence grating 13a and the optical waveguide layer 12. Further, the laser beam propagates, while being refracted more than twice at the interface between the optical waveguide layer 12 and substrate 11 and at the sensing surface 23 that is the interface between the optical waveguide layer 12 and the sensing film 22. The light, which has propagated through the optical waveguide layer 12, is emitted from the back surface of the substrate 11 via the emission grating 13b, and the light is received by the photodiode serving as the light reception element 19.

In this state, the specimen 27 is injected from the outside of the chamber 16 via the liquid feed path 16e. The specimen 27 is introduced into the specimen area 20 through the liquid feed path 16e. At this time, since the air or fluid, which is present in the specimen area 20, is let to escape from the escape portion 16f that is formed in the chamber 16, the liquid feed can smoothly be performed.

Immediately after the specimen 27 is introduced in the specimen area 20 by the liquid feed, the inside of the specimen area 20 is stirred by the stirring mechanism 26, and is then left for a predetermined time. By the stirring and leaving of the specimen 27, the separation between the to-be-measured substance and the precipitate 27a in the specimen 27 is accelerated. By the stirring, the precipitate 27a can uniformly be deposited, and is prevented from being concentratedly precipitated at one location. The separated precipitate 27a deposits on the precipitation surface 21 that is the lower surface of the specimen area 20. Since the sensing surface 23 is the upper surface of the specimen area 20, the precipitate 27a is eliminated from the sensing surface 23 by the precipitation.

In this case, evanescent waves of the light propagating through the optical waveguide layer 12 are absorbed in accordance with a variation (e.g. absorbance variation) based on a biochemical reaction of biomolecules in the specimen 27 in the sensing film 22 at the time of refraction at the sensing surface 23.

The light, which has propagated through the optical waveguide layer 12, is emitted from the back surface of the substrate 11 via the emission grating 13b, and is received by the photodiode serving as the light reception element 19. The intensity of the received laser beam becomes lower than the intensity (initial intensity) of a laser beam which would be received when no biochemical reaction occurs between the sensing film 22 and biomolecules, and the amount of biomolecules can be detected from the ratio of the decrease in light intensity.

According to the optical sensor 1 of the embodiment, the following advantageous effects can be obtained. Specifically, since the sensing surface 23 and the precipitation surface 21 are disposed at different positions, the influence of the precipitate 27a upon the detection result can be prevented.

For example, when the specimen 27 is blood, the blood can be introduced into the specimen area 20 without separating blood cells from the blood in advance, and the measurement can be performed without the influence by the blood cells that are the precipitate 27a. Moreover, the influence of the precipitate 27a can be avoided by the simple structure in which the specimen area 20 is downwardly disposed, without making complex the structure of the optical sensor 1.

### Second Embodiment

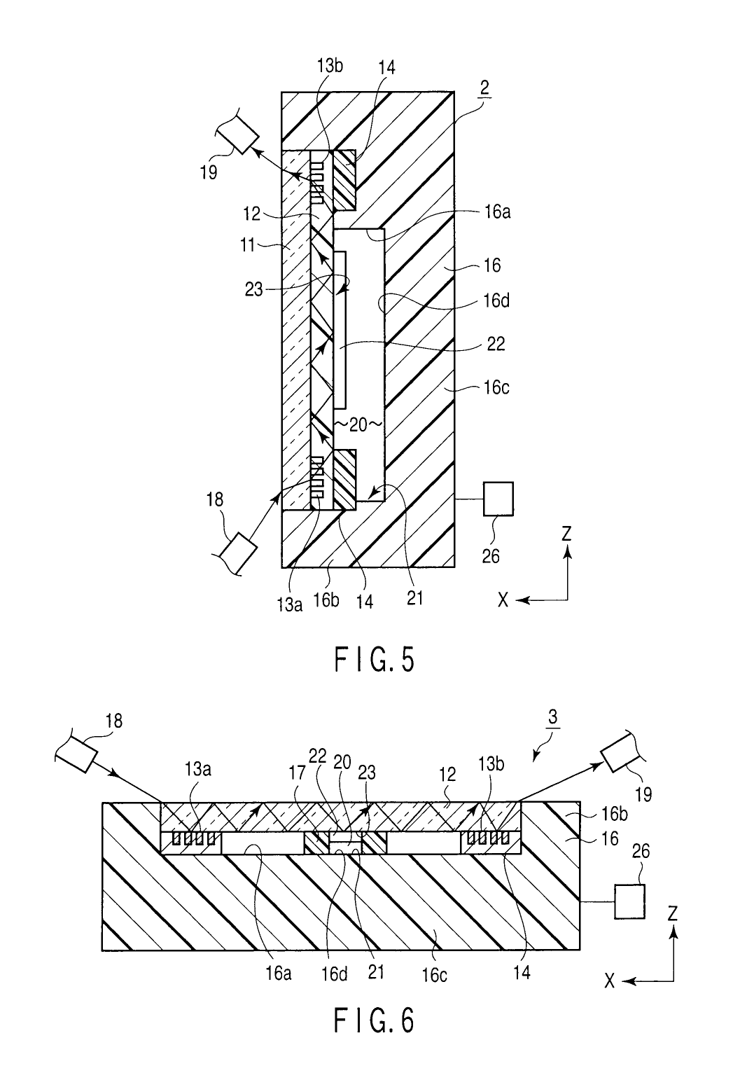

Referring to FIG. 5, an optical sensor 2 according to a second embodiment of the invention is described. The optical sensor 2 of the second embodiment is the same as the optical sensor 1 of the first embodiment, except for the direction of the optical sensor 2 and the arrangement of the specimen area 20. Thus, a description of the common parts is omitted here.

FIG. 5 is a cross-sectional view of the optical sensor 2 of the second embodiment. The optical sensor 2 is laterally disposed. Specifically, a sensor chip 15 is constituted such that a substrate 11, an optical waveguide layer 12, gratings 13a and 13b, and a protection film 14 are stacked in the horizontal direction (X direction). A chamber 16 is disposed to be opposed to the sensor chip 15.

A recess portion 16a is formed in one side surface (left side in FIG. 5) in the X direction of the chamber 16. The recess portion 16a is disposed with a downward bias from the center in the Z direction. A specimen area 20 is formed between the bottom side wall of the chamber 16 and the sensor chip 15. In the lower part of the specimen area 20, the protection film 14 is disposed between the specimen area 20 and the optical waveguide layer 12. This protection film 14 serves as a partition wall portion. In the optical sensor 2 according to this embodiment, the specimen area 20 and the optical waveguide layer 12 are disposed to neighbor each other in the X direction, and the protection film 14 serving as the partition wall portion is disposed below a boundary part between the specimen area 20 and optical waveguide layer 12. In other words, the specimen area 20 is provided to neighbor the optical waveguide layer 12 in the horizontal direction, and the protection film 14 serving as the partition wall portion is formed between the lower part of the specimen area and the optical waveguide layer.

In the optical sensor 2 with the above-described structure, one side surface in the X direction of the specimen area 20, which is the interface between the specimen area 20 and the optical waveguide layer 12, is a sensing surface 23 (sensing area), and the lower surface of the specimen area 20 is a precipitation surface 21.

Specifically, the sensing surface 23, which is the side surface, and the precipitation surface 21, which is the lower surface, are disposed at different positions and are disposed in different planes crossing at an angle of 90°. Furthermore, the lower region in the specimen area 20 is isolated from the optical waveguide layer 12 by the protection film 14. Hence, in the specimen area 20, the precipitate 27a deposits in the lower region, but the precipitate 27a does not come in contact with the sensing surface 23 since the protection film 14 is disposed on the left side of this lower region.

In the optical sensor 2 with the above-described structure, like the first embodiment, after the specimen 27 is introduced in the specimen area 20, the specimen 27 is stirred and left as it stands. Thereby, the separation between the to-be-measured substance and the precipitate 27a in the specimen 27 is accelerated.

The precipitate 27a moves downward by its own weight, and comes to the region which is isolated from the optical waveguide layer 12 by the protection film 14 that is the partition wall portion. Therefore, the precipitate 27a is eliminated from the sensing surface 23.

According to the present embodiment, the same advantageous effects as with the first embodiment can be obtained. Specifically, since the sensing surface 23 and the precipitation surface 21 are disposed at different positions, the influence of the precipitate 27a upon the detection of the to-be-measured substance can be avoided. Moreover, since the protection film 14 functions as the partition wall portion in the present embodiment, the precipitate 27a can surely be eliminated from the sensing surface 23.

### Third Embodiment

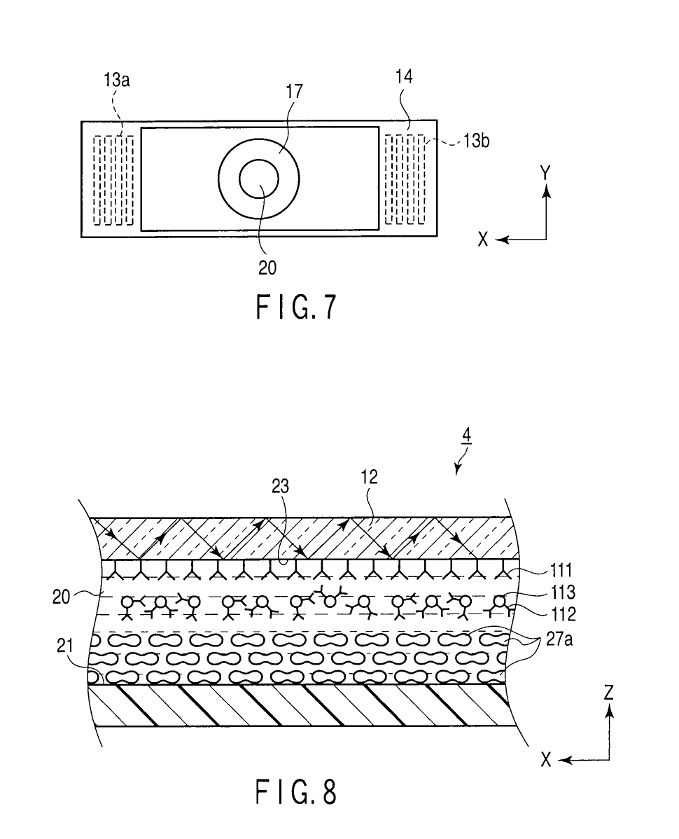

Referring to FIG. 6 and FIG. 7, an optical sensor 3 according to a third embodiment of the invention is described. The optical sensor 3 of the third embodiment is the same as the optical sensor 1 of the first embodiment, except for the provision of a glass waveguide layer and the structure of the side wall portion 16b. Thus, a description of the common parts is omitted here.

The optical sensor 3 is a waveguide-type biochemical sensor chip using, for example, a glass waveguide layer. The optical sensor 3 comprises a light-transmissive optical waveguide layer 12; a specimen area 20 which is formed on a lower major surface of the optical waveguide layer 12; a sensing film 22 provided in the specimen area 20; an incidence grating 13a and an emission grating 13b which are disposed on both sides of the specimen area 20 such that the specimen area 20 is interposed; a peripheral wall portion 17 which is formed of a water-repellent resin in a manner to surround the specimen area 20; a protection film 14 surrounding the specimen area 20; and a chamber 16 having an opposite surface 16d which is opposed to the total-reflection layer via the specimen area 20. A light source 18 (e.g. laser diode) and a light-reception element 19 (e.g. photodiode), which are optical elements, are disposed, respectively, on one end side and the other end side of the back surface of the optical waveguide layer 12. Specifically, in the first embodiment, the light-transmissive substrate 11 is provided to neighbor the optical waveguide layer 12 on that side of the optical waveguide layer 12, which is opposite to the specimen area 20. In the present embodiment, however, an additional substrate is not provided on the upper side of the optical waveguide layer 12, and a substrate itself, which becomes the total-reflection layer, functions as the optical waveguide layer 12.

The optical waveguide layer 12 (total-reflection layer) is a substrate which is formed of quartz (silicon oxide) in a plate shape. Incident light travels through the optical waveguide layer 12, while undergoing total reflection.

The incidence grating 13a and emission grating 13b, which are spaced apart, are formed in contact with the lower surface of the optical waveguide layer 12.

The gratings 13a and 13b are formed of a material having a higher refractive index than the material of the optical waveguide layer 12. For example, titanium oxide, zinc oxide, lithium niobate, gallium-arsenic, indium-tin-oxide, polyimide, tantalum oxide, etc. is deposited by chemical vapor deposition (CVD). By pattering the deposited structure by a lithography technique and a dry etching technique, the gratings 13a and 13b are formed.

The sensing film 22 is provided in the specimen area 20. The sensing film 22 is in contact with the optical waveguide layer 12, and is provided between the incidence grating 13a and emission grating 13b. The sensing film 22 includes, as reaction reagents 25, for example, an enzyme and a coloring reagent. These reaction reagents 25 are fixed in the form of a gel by, e.g. cellulose derivatives serving as holding structures 24. The upper surface of the specimen area 20, or the upper surface of the sensing film 22, which is the interface between the specimen area 20 and the optical waveguide layer 12, becomes a sensing surface 23 (sensing area). On the other hand, the lower surface of the specimen area 20 becomes a precipitation surface 21 on which the precipitate 27a of specimen 27 precipitates.

The peripheral wall portion 17 is formed of, e.g. a water-repellant resin, and is configured to include a wall member which is formed in an annular shape surrounding the specimen area 20.

The protection film 14 surrounds the sensing film 22 and covers the incidence grating 13a and emission grating 13b. The protection film 14 is formed by coating a material, such as a fluororesin, which has a lower refractive index than the incidence grating 13a and emission grating 13b.

In the optical sensor 3 having the above-described structure, light, which is made incident from the light emission element, diffracts at the incidence grating 13a, and travels through the optical waveguide layer 12 while undergoing total reflection. When the light is refracted at the sensing surface 23 which is the boundary surface between the optical waveguide layer 12 and the sensing film 22, evanescent waves are absorbed by the coloring of the sensing film 22. Accordingly, the light is absorbed, for example, in proportion to the degree of coloring of the sensing film 22, that is, the amount of the to-be-measured substance. The light, which ultimately reaches the emission grating 13b, is emitted from the optical waveguide layer 12 to the light reception element 19. The amount of the to-be-measured substance is calculated from the difference between the amount of light emitted from the light emission element and the amount of light received by the light reception element 19.

According to the present embodiment, the same advantageous effects as with the first and second embodiments can be obtained. Specifically, since the sensing surface 23 is disposed to be opposed to the precipitation surface 21, the precipitate 27a is prevented from coming in contact with the sensing surface 23, and the influence of the precipitate 27a can be avoided.

### Fourth Embodiment

Next, referring to FIG. 8 to FIG. 10, a description is given of a reaction behavior in the sensing film 22 in a fourth embodiment of the invention in the case where an antigen-antibody reaction is used.

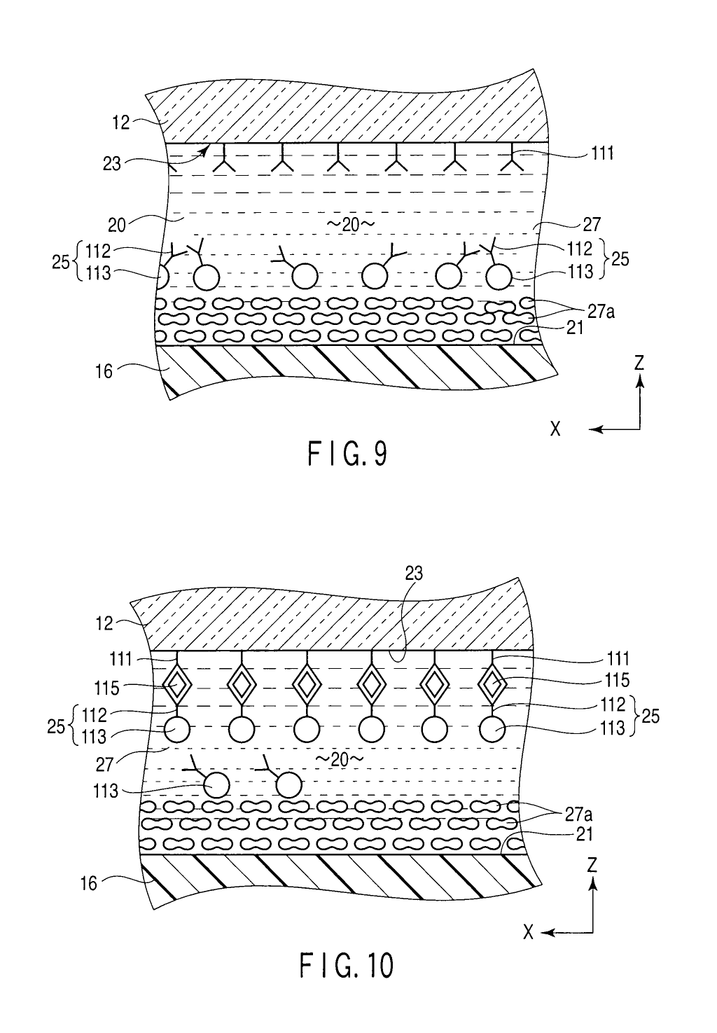

FIG. 8 is an enlarged view of the specimen area 20, and FIG. 9 and FIG. 10 are explanatory views illustrating an antigen-antibody reaction.

To-be-measured substances are, for instance, blood, serum, plasma, a biological sample, a protein included in food, etc., a peptide, and a gene.

Concrete examples are insulin, casein, β-lactoglobulin, ovalbumin, calcitonin, C-peptide, leptin, β-2-microglobulin, retinol-binding protein, α-1-microglobulin, α-fetoprotein, carcinoembryonic antigen, troponin-I, glucagon-like peptide, insulin-like peptide, a tumor growth factor, a fibroblast growth factor, a platelet growth factor, an epidermal growth factor, cortisol, triiodothyronine, hapten hormone such as thyroxine, digoxin, a medicine such as theophyline, infectious substances such as bacteria and viruses, hepatitis antibody, IgE, a complex of major proteins of buckwheat, and soluble proteins including Arah2 of peanuts. However, the to-be-measured substances are not limited to these examples.

In the case of using the antigen-antibody reaction, the optical waveguide layer 12 can be formed of a thermosetting resin such as a phenol resin or an epoxy resin, or no-alkali glass. The material that is used in this case is a material having predetermined light transmissivity, and in particular, an epoxy resin having a main structure of polystyrene is preferable.

In the sensing film 22, a first substance, which specifically reacts with a to-be-measured substance of the specimen 27, is fixed as the reaction reagents 25. For example, the first substance is fixed on the surface, which has been subjected to a hydrophobicity-imparting process by, e.g. a silane-coupling agent, by a hydrophobic interaction of the substance. As the first substance, for example, an antibody can be used when the to-be-measured substance of the specimen 27 is an antigen.

The holding structure 24 of the to-be-measured substance in the sensing film 22 may be a mode in which particles are dispersed on the waveguide surface via a blocking layer. The blocking layer includes a water-soluble substance, such as polyvinyl alcohol, bovine serum albumin (BSA), polyethylene glycol, a phospholipid polymer, gelatine, or sugars (e.g. sucrose, trehalose). The blocking layer may further include a protein inhibiter.

As the particles, use may be made of resin beads such as latex beads (trade name) of polystyrene, a metal colloid such as a gold colloid, or inorganic oxide particles such as titanium oxide particles. In addition, as the particles, use may also be made of a protein such as albumin, a polysaccharide such as agarose, or nonmetal particles such as silica particles or carbon particles. In particular, latex beads and metal colloid are preferable. Of the latex beads, blue latex beads are preferable when the light that propagates through an optical waveguide is a red laser beam (to be described later). Preferably, the particles should have a grain size of 50 nm to 10 μm.

As the reaction reagents 25, a second substance, which specifically reacts with the to-be-measured substance, is fixed to the particles. As the second substance, antibodies are fixed to the particles when the to-be-measured substance of the specimen 27 is, for example, antigens.

The antigen-antibody reaction is explained below. As shown in FIG. 9, if there are no antigens which specifically react with first antibodies 111 and the second antibodies of the particles 113 in the specimen 27, the second antibodies 112 of the particles 113 are dispersed without being coupled to the first antibodies 111 on the surface of the optical waveguide layer 12. The second antibodies 112 and particles 113 function as the reaction reagents 25.

In this state, even if a red laser beam from the light source 18 is made incident on the optical waveguide layer 12 from the incidence grating 13a and the incident beam is caused to propagate through the optical waveguide layer 12, thereby to generate evanescent light in the vicinity of the surface (sensing area), few particles 113 are present in the evanescent light region since the particles 113 in the specimen 27 in the specimen area 20 are dispersed. Specifically, since the particles 113 are hardly involved in the absorption or scattering of the evanescent light, there occurs substantially no attenuation of the intensity of the evanescent light. As a result, when the red laser beam, which emanates from the emission grating 13b, is received by the photodiode, the laser beam intensity hardly varies.

On the other hand, as shown in FIG. 10, if there are antigens 115 in the specimen 27, the antigens 115 effect antigen-antibody reactions with the first antibodies 111 on the surface of the optical waveguide layer 12 and are coupled to the first antibodies 111. Further, the second antibodies 112 of the particles 113 effect antigen-antibody reactions with the antigens 115 and are coupled to the antigens 115. Specifically, since the antigen-antibody reactions occur via the antigens 115 between the first antibodies 111 on the surface of the optical waveguide layer 12 and the second antibodies 112 of the particles 113, the particles 113 are fixed to the surface of the optical waveguide layer 12.

For example, if the red laser beam from the red laser diode serving as the light source 18 is made incident on the optical waveguide layer 12 from the incidence grating 13a and the incident beam is caused to propagate through the optical waveguide layer 12, thereby to generate evanescent light in the vicinity of the sensing surface 23, the particles 113 are present in the evanescent light region since the particles 113 are fixed to the surface of the optical waveguide layer 12 (sensing surface 23). Specifically, since the particles 113 are involved in the absorption or scattering of the evanescent light, there occurs an attenuation of the intensity of the evanescent light. As a result, when the laser beam, which emanates from the emission grating 13b, is received by the photodiode that is the light reception element 19, the laser beam intensity decreases with the passing of time due to the influence of the fixed particles 113.

The ratio of the decrease in the intensity of the laser beam received by the light reception element 19 is proportional to the amount of particles 113 fixed to the surface of the optical waveguide layer 12, that is, the concentration of antigens in the specimen 27, which are involved in the antigen-antibody reactions. Thus, a decrease curve of the laser beam intensity with the passing of time in the specimen 27, in which the concentration of antigens is known, is prepared. The ratio of decrease of the laser beam intensity at a predetermined time on the curve is calculated, and an analytical curve indicating the relationship between the antigen concentration and the ratio of decrease of the laser beam intensity is prepared in advance. The ratio of decrease in laser beam intensity at a predetermined time is calculated from the time that is measured by the above method and the decrease curve of the laser beam intensity. By collating this ratio of decrease of the laser beam intensity and the analytical curve, the antigen concentration in the specimen 27 can be measured.

The invention is not limited to the above-described embodiments. In practice, various modifications may be made without departing from the spirit of the invention. For example, the optical sensor 1 is downwardly disposed in the first embodiment, and the optical sensor 2 is laterally disposed in the second embodiment. However, the invention is not limited to these embodiments. For example, the optical sensor may be disposed obliquely. If the specimen area 20 has a rectangular parallelepiped shape, for instance, the precipitation surface 21 and sensing surface 23 can be set in different planes by inclining the specimen area 20 from the upwardly disposed state over angles between 90° and 270°.

In the above embodiments, all surfaces of the chamber 16 are black surfaces. Alternatively, a black surface may be used for only the surface at which evanescent light occurs, or the opposite surface 16d which is opposed to the upper surface of the layer in which light is guided. In addition, the chamber 16 and sensor chip 15 may be coupled by using a double-coated light-blocking tape at a location outside the specimen area 20.

In order to realize the stirring mechanism 26, the pump which uses a motor has been described by way of example. Alternatively, an actuator, magnetic particles, a SAW device, a piezo-element, etc. may be used.

Various inventions can be made by properly combining the structural elements disclosed in the embodiments. For example, some structural elements may be omitted from all the structural elements disclosed in the embodiments. Furthermore, structural elements in different embodiments may properly be combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An optical sensor comprising:
an optical waveguide module; and
a specimen area provided adjacent to the optical waveguide module, configured to hold a specimen, and including a sensing area and a precipitation area, an optical change occurring in the sensing area, a precipitate of the specimen being precipitated in the precipitation area, the precipitation area being placed at a different position from a position of the sensing area which is attached to the optical waveguide module.

2. The optical sensor of claim 1, further comprising a chamber which is disposed to be opposed to the optical waveguide module, the specimen area being formed between the chamber and the optical waveguide module.

3. The optical sensor of claim 1, wherein the specimen area has reactive reagents, the reaction reagents reacting with the specimen, thereby causing an optical change depending an amount of a to-be-measured substance in the sensing area.

4. The optical sensor of claim 1, wherein the specimen area is provided to laterally neighbor the optical waveguide module, and
a partition wall portion exists between a lower part of the specimen area and the optical waveguide module.

5. The optical sensor of claim 1, further comprising a stirring mechanism configured to stir the specimen in the specimen area.

6. The optical sensor of claim 2, wherein the chamber includes a liquid feed path configured to introduce the specimen into the specimen area, and an escape portion configured to cause a liquid in the specimen area to escape when the specimen is introduced into the specimen area.
